(19) United States
(12) Patent Application Publication
(10) Pub. No.: US 2008/0300848 A1
(43) Pub. Date: Dec. 4, 2008

(54) EFFICIENT SIMULATION OF DOMINANTLY LINEAR CIRCUITS

(76) Inventors: Michael W. Beattie, Muenchberg (DE); Byron L. Krauter, Leander, TX (US); Hui Zheng, Round Rock, TX (US)

Correspondence Address: IBM CORPORATION (JVM), C/O LAW OFFICE OF JACK V. MUSGROVE, 2911 BRIONA WOOD LANE, CEDAR PARK, TX, 78613, US

(21) Appl. No.: 12/189,813

(22) Filed: Aug. 12, 2008

Related U.S. Application Data
(63) Continuation of application No. 11/301,731, filed on Dec. 13, 2005.

(51) Int. Cl. G06G 7/48

(52) U.S. Cl. 703/14

(57) ABSTRACT

A method of simulating a circuit parameter such as voltage or current for a dominantly linear circuit by constructing a circuit equation matrix whose elements correspond to nodes of the circuit, decoupling linear and nonlinear contributions to the circuit parameter based on a partition of an inverse matrix of the circuit equation matrix, computing linear and nonlinear components using the decoupled contributions, and combining the nonlinear and linear components to yield a state of the circuit parameter for a given time step. The computation of the nonlinear component includes Newton-Raphson iterations to linearize nonlinear devices of the circuit, wherein the Newton-Raphson technique is applied to the right-hand side of the circuit state matrix equation. The computations are iteratively repeated for successive time steps which are advantageously separated by a constant time interval to avoid further recalculation of the state matrix.

### CROSS-REFERENCE TO RELATED APPLICATION

This application is a continuation of copending U.S. patent application Ser. No. 11/301,731 filed Dec. 13, 2005.

### BACKGROUND OF THE INVENTION

1. Field of the Invention

The present invention generally relates to the fabrication and design of semiconductor chips and integrated circuits, and more particularly to a method of simulating a circuit parameter such as voltage or current for a circuit having linear components and nonlinear components.

2. Description of the Related Art

Integrated circuits are used for a wide variety of electronic applications, from simple devices such as wristwatches, to the most complex computer systems. A microelectronic integrated circuit (IC) chip can generally be thought of as a collection of logic cells with electrical interconnections between the cells, formed on a semiconductor substrate (e.g., silicon). An IC may include a very large number of cells and require complicated connections between the cells. A cell is a group of one or more circuit elements such as transistors, capacitors, resistors, inductors, and other basic circuit elements grouped to perform a logic function. Cell types include, for example, core cells, scan cells and input/output (I/O) cells. Each of the cells of an IC may have one or more pins, each of which in turn may be connected to one or more other pins of the IC by wires. The wires connecting the pins of the IC are also formed on the surface of the chip. For more complex designs, there are typically at least four distinct layers of conducting media available for routing, such as a polysilicon layer and three metal layers (metal-1, metal-2, and metal-3). The polysilicon layer, metal-1, metal-2, and metal-3 are all used for vertical and/or horizontal routing.

An IC chip is fabricated by first conceiving the logical circuit description, and then converting that logical description into a physical description, or geometric layout. This process is usually carried out using a “netlist,” which is a record of all of the nets, or interconnections, between the cell pins. A layout typically consists of a set of planar geometric shapes in several layers. The layout is then checked to ensure that it meets all of the design requirements, particularly timing requirements. The result is a set of design files known as an intermediate form that describes the layout. The design files are then converted into pattern generator files that are used to produce patterns called masks by an optical or electron beam pattern generator. During fabrication, these masks are used to pattern a silicon wafer using a sequence of photolithographic steps. The process of converting the specifications of an electrical circuit into a layout is called the physical design.

Cell placement in semiconductor fabrication involves a determination of where particular cells should optimally (or near-optimally) be located on the surface of a integrated circuit device. Due to the large number of components and the details required by the fabrication process for very large scale integrated (VLSI) devices, physical design is not practical without the aid of computers. As a result, most phases of physical design extensively use computer-aided design (CAD) tools, and many phases have already been partially or fully automated. Automation of the physical design process has increased the level of integration, reduced turn around time and enhanced chip performance. Several different programming languages have been created for electronic design automation (EDA), including Verilog, VHDL and TDML. A typical EDA system receives one or more high level behavioral descriptions of an IC device, and translates this high level design language description into netlists of various levels of abstraction.

Faster performance and predictability of responses are elements of interest in circuit designs. As process technology scales to the deep-submicron (DSM) regime, the metal interconnects for signals and power distribution are becoming increasingly important to the performance and reliability of IC chips and systems. Consequently, physical design optimization tools for power and signal integrity have become crucial to achieving an accurate system analysis. For such a tool to be effective, it must be able to efficiently compute circuit parameters of concern since several million calculations are required to optimize a design. Circuit parameters such as voltage or current (and other parameters derived therefrom) are affected by circuit topology and circuit components, in particular circuits having resistive, inductive and capacitive elements, or RLC circuits. Circuit designers continually search for efficient techniques for accurate estimation of these parameters while determining the circuit's response to a load.

RLC circuits are referred to as linear circuits because the equations governing parameters such as voltage or current in those circuits are linear relationships. However, for power and signal integrity analysis in chips and packages, it is often necessary to simulate circuits that contain a relatively large linear network modeling signal and power interconnects with a few nonlinear devices modeling I/O drivers (a dominantly linear circuit). One generalized example of such a circuit 1 is shown in FIG. 1. Dominantly linear circuit 2 includes an RLC network 4 which may be for example a power grid having more than 100,000 nodes, which is driven by a nonlinear field-effect transistor (FET) pair 6. Dominantly linear circuits are commonly seen in on-chip and off-chip electrical analyses, such as signal integrity analysis or chip-package co-simulation. In such a circuit, it is critical to include the nonlinearity as part of the circuit simulation in order to arrive at the correct circuit response.

The traditional technique for modeling a circuit having linear and nonlinear components employs transistor-level simulators for transient analysis flow. One such prior art tool known as SPICE uses numerical integration formulae to form companion models for capacitors and inductors at each successive point in time. FIG. 2 illustrates the process for a typical SPICE nonlinear transient simulation. An input file is provided that contains a description of the circuit with resistance, inductance and capacitance values corresponding to respective nodes as well as nonlinear devices such as transistors or diodes (8). A nonlinear DC analysis is then performed considering all circuit nodes at an initial time, i.e., an infinite time step (10), as explained further below in conjunction with FIG. 3. The DC condition represents a steady state, i.e., no voltages or currents are changing with respect to time, and capacitors are represented as open circuits while inductors are closed (shorted). The time variable is then incremented (12), and an equivalent nonlinear DC analysis is performed considering all circuit nodes at that next time step (14). In the equivalent analysis, capacitors and inductors are represented as companion models, e.g., a capacitor is represented as a resistor in parallel with a current source (as a function of the time step), and an inductor is represented as a resistor in series with a voltage source. The process repeats for each time step until the final time step is reached (16).

The nonlinear DC analysis linearizes nonlinear devices based on a Newton-Raphson iteration, and assembles a set of linear circuit equations using modified nodal analysis (MNA), as shown in FIG. 3. Newton-Raphson iteration is a numerical technique for solving the roots of a nonlinear equation. The Newton-Raphson process begins with an initial guess X⁰ for the roots during the first iteration k=0 (18). Nonlinear devices are then linearized about X^{k} (20). The system of linear equations is represented by the formula GX=b, where G is the MNA circuit matrix, b is the set of starting (input) values, and X is the circuit parameter of interest, e.g., voltage or current. The analysis computes a perturbation ΔG to the circuit matrix and assembles the linear equations from G+ΔG (22). The circuit is then simulated (for each time step) by iteratively solving the system of linear equations using Gaussian elimination (24). The current roots X^{k+1} are compared with the previous roots X^{k} to determine if the difference is within a user-defined error tolerance (26). If the difference is smaller than the threshold then the solution is converging and the process is complete; if not, the process continues iteratively at step 20, incrementing k (28).

SPICE-like simulators are useful for analyzing small circuits with both linear and nonlinear devices and, if a fixed time-step option is also available, for analyzing large circuits with only linear devices. However, SPICE-like simulators are extremely inefficient in simulating large dominantly linear circuits that contain even a single nonlinear device since every Newton-Raphson iteration forms a new circuit matrix G. The Gaussian elimination of the MNA matrix uses triangular decomposition, also referred to as lower/upper (LU) factorization, followed by backward/forward substitution. The per-iteration cost of transient simulation is dominated by LU factorization of the circuit matrix G, and can become overwhelming since a new large linear system has to be solved at each iteration. It would, therefore, be desirable to devise a more efficient method of simulating dominantly linear circuits which would not require excessive iterations involving large sets of linear circuit equations. It would be further advantageous if the method were usable with a wide variety of circuit structures.

### SUMMARY OF THE INVENTION

It is therefore one object of the present invention to provide an improved method of simulating circuit parameters such as voltage or current in an integrated circuit design.

It is another object of the present invention to provide such a method which efficiently simulates circuit parameters of a dominantly linear circuit having a relatively small number of nonlinear elements.

It is yet another object of the present invention to provide a scheme to speed up the simulation of dominantly linear circuits using transient analysis flow.

The foregoing objects are achieved in a method of simulating a circuit parameter such as voltage or current for a dominantly linear circuit, by constructing a circuit equation matrix whose elements correspond to nodes of the circuit, defining linear, nonlinear and mixed contributions to the circuit parameter based on a partition of an inverse matrix of the circuit equation matrix, computing a nonlinear component using the nonlinear contribution and a first mixed contribution, computing a linear component using the linear contribution and a second mixed contribution, and combining the nonlinear and linear components to yield a state of the circuit parameter for a given time step. The computations are iteratively repeated for successive time steps which are advantageously separated by a constant time interval. The computation of the nonlinear component includes Newton-Raphson iterations to linearize nonlinear devices of the circuit. In particular, the nonlinear component X_{NL}^{k+1} for a given time step k+1 may be iteratively computed using the relationship

X_{NL}^{k+1}=(R_{NL}R_{NN})I_{L}+R_{NN}[I_{NL}X_{NL}^{k}+J_{NL}^{k}(X_{NL}^{k}−X_{NL}^{k})],

where R_{NL} is a submatrix of the inverse matrix corresponding to the mixed contributions, R_{NN} is a submatrix of the inverse matrix corresponding to the nonlinear contribution, I_{L} is a contribution of all linear devices of the circuit, I_{NL} is a contribution of all nonlinear devices of the circuit, and J_{NL}^{k} is a Jacobian matrix for all nonlinear devices of the circuit. The linear component X_{L}^{k+1} for a given time step k+1 may be iteratively computed using the relationship

X_{L}^{k+1}=(R_{LL}R_{LN})I_{L}+R_{LN}[I_{NL}X_{NL}^{k}+J_{NL}^{k}(X_{NL}^{k+1}−X_{NL}^{k})]

where R_{LL} is a submatrix of the inverse matrix corresponding to the linear contribution and R_{LN} is another submatrix of the inverse matrix corresponding to the mixed contributions. The iterations terminate once the convergence condition

$$\vert Δ X \vert \leq \vert ( \begin{matrix}{R}_{LN} \\ {R}_{NN}\end{matrix} ) \vert \vert {J}_{NL}^{k} Δ {X}_{NL} \vert < ɛ$$

is satisfied, where ΔX is X^{k+1}(iteration i+1)−X^{k+1}(iteration i), ΔX_{NL} is X_{NL}^{k+1}(iteration i+1)−X_{NL}^{k+1}(iteration i), and ε is a user-defined error tolerance.

The above as well as additional objectives, features, and advantages of the present invention will become apparent in the following detailed written description.

### BRIEF DESCRIPTION OF THE DRAWINGS

The present invention may be better understood, and its numerous objects, features, and advantages made apparent to those skilled in the art by referencing the accompanying drawings.

FIG. 1 is a schematic diagram of a dominantly linear circuit to be analyzed, the circuit having a linear portion (an RLC network) and a nonlinear portion (a transistor pair);

FIG. 2 is a chart illustrating the logical flow for a conventional transient analysis technique which iteratively solves a large number of linear circuit equations;

FIG. 3 is a chart illustrating the logical flow for a conventional nonlinear DC analysis which includes a Newton-Raphson iteration and factorization of a circuit state matrix;

FIG. 4 is a block diagram of a computer system programmed to carry out simulation of a dominantly linear circuit in accordance with one implementation of the present invention;

FIG. 5 is a pictorial representation of the partitioning of an inverse state matrix and decoupling of the nonlinear and linear components of the right-hand side of a circuit equation;

FIG. 6 is a chart illustrating the logical flow of circuit simulation in accordance with one implementation of the present invention; and

FIG. 7 is a chart illustrating the logical flow for linearizing nonlinear devices in accordance with one implementation of the present invention.

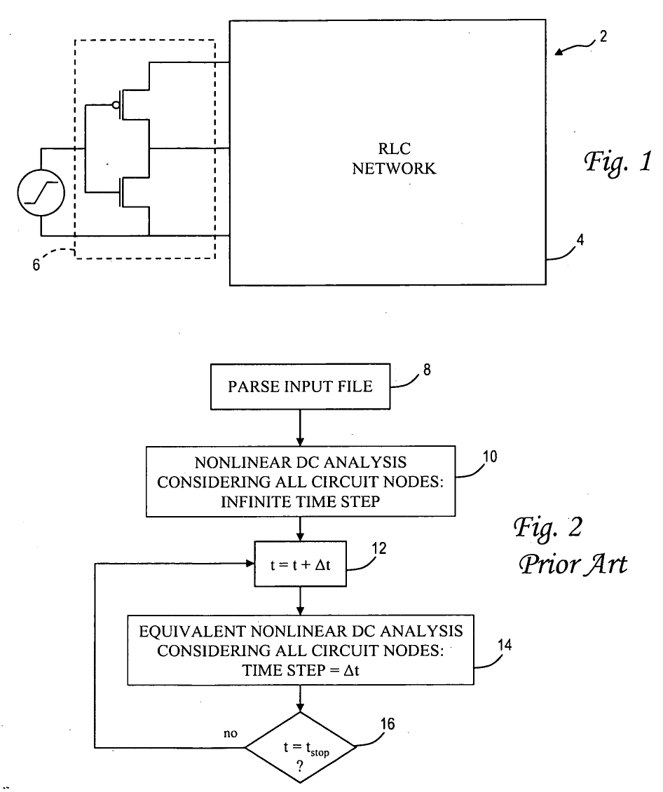

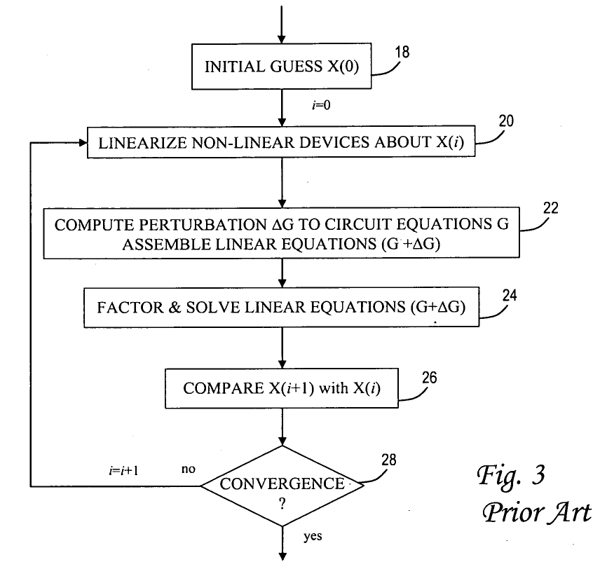

The use of the same reference symbols in different drawings indicates similar or identical items.

### DESCRIPTION OF THE PREFERRED EMBODIMENT(S)

The present invention provides a method for the efficient simulation of dominantly linear circuits using a reduced Newton-Raphson technique and reused factorization with a direct solver, as explained more fully below. A “dominantly linear circuit” refers to a circuit wherein the linear portions (e.g., resistive, capacitive and inductive elements) significantly outweigh the nonlinear portions (e.g., transistors or diodes). Although the present invention is applicable to circuits having a fairly large nonlinear portion, it is deemed most efficient when applied to a circuit in which the nonlinear portion is no more than about 1% of the circuit elements.

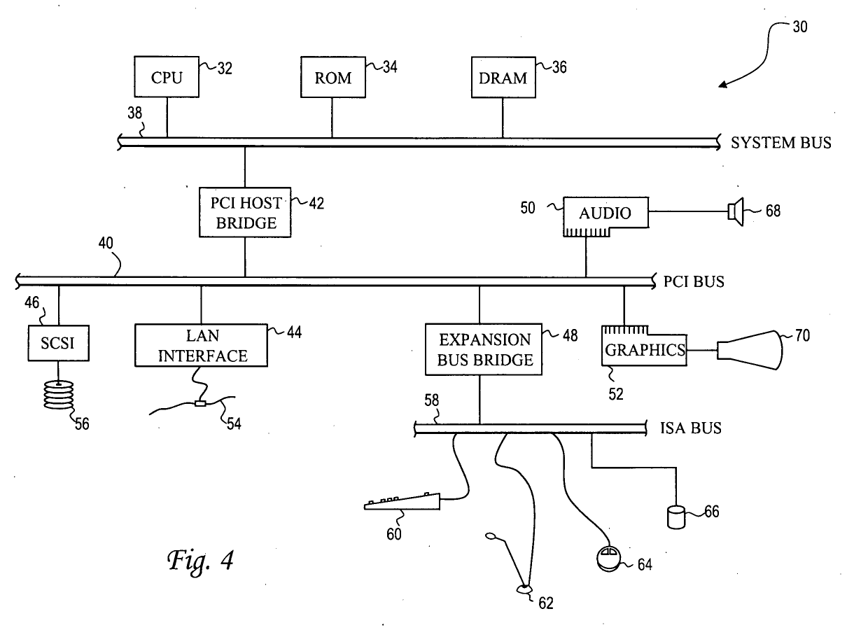

With reference now to the figures, and in particular with reference to FIG. 4, there is depicted one embodiment 30 of a computer system programmed to carry out the simulation of a dominantly linear circuit in accordance with one implementation of the present invention. System 30 includes a central processing unit (CPU) 32 which carries out program instructions, firmware or read-only memory (ROM) 34 which stores the system's basic input/output logic, and a dynamic random access memory (DRAM) 36 which temporarily stores program instructions and operand data used by CPU 32. CPU 32, ROM 34 and DRAM 36 are all connected to a system bus 38. There may be additional structures in the memory hierarchy which are not depicted, such as on-board (L1) and second-level (L2) caches. In high performance implementations, system 30 may include multiple CPUs and a distributed system memory.

CPU 32, ROM 34 and DRAM 36 are coupled to a peripheral component interconnect (PCI) local bus 40 using a PCI host bridge 42. PCI host bridge 42 provides a low latency path through which processor 32 may access PCI devices mapped anywhere within bus memory or I/O address spaces. PCI host bridge 42 also provides a high bandwidth path to allow the PCI devices to access DRAM 36. Attached to PCI local bus 40 are a local area network (LAN) adapter 44, a small computer system interface (SCSI) adapter 46, an expansion bus bridge 48, an audio adapter 50, and a graphics adapter 52. LAN adapter 44 may be used to connect computer system 30 to an external computer network 54, such as the Internet. A small computer system interface (SCSI) adapter 46 is used to control high-speed SCSI disk drive 56. Disk drive 56 stores the program instructions and data in a more permanent state, including the program which embodies the present invention as explained further below. Expansion bus bridge 48 is used to couple an industry standard architecture (ISA) expansion bus 58 to PCI local bus 40. As shown, several user input devices are connected to ISA bus 58, including a keyboard 60, a microphone 62, and a graphical pointing device (mouse) 64. Other devices may also be attached to ISA bus 58, such as a CD-ROM drive 66. Audio adapter 50 controls audio output to a speaker 68, and graphics adapter 52 controls visual output to a display monitor 70, to allow the user to carry out the circuit simulation as taught herein.

While the illustrative implementation provides the program instructions embodying the present invention on disk drive 56, the invention can be embodied in a program product utilizing other computer-readable media, including transmission media. The program instructions may be written in the C++ programming language for an AIX environment.

Computer system 30 carries out program instructions for a simulation process which constructs a circuit equation matrix whose elements correspond to nodes of the circuit, and defines linear, nonlinear and mixed contributions to the circuit parameter based on a partition of the inverse of the circuit equation matrix. A nonlinear component is computed using the nonlinear contribution and a mixed contribution, and a linear component is computed using the linear contribution and a mixed contribution. The nonlinear and linear components can then be combined to compute voltages or currents for a given time step, as well as other values derived from these parameters such as current densities, heat generation, etc. The invention is particularly suited to analysis of power and signal integrity. Accordingly, the program instructions embodying the invention may include additional features representative of conventional circuit simulation tools as will become apparent to those skilled in the art.

As discussed in the Background section, the set of linear equations governing a circuit can be expressed as Ax=b where A is the modified nodal analysis (MNA) circuit matrix, b is the set of starting (input) values, and x is the circuit parameter of interest, e.g., voltage or current. For a circuit having nonlinear elements, i.e., where a generic nonlinear device is defined by a function of several node voltages and/or branch currents, one way to formulate the nonlinear equations in both the DC analysis and the inner-loop transient analysis is

$${G}_{L} X = {G}_{L} ( \begin{matrix}{X}_{L} \\ {X}_{NL}\end{matrix} ) = {I}_{L} + ( \begin{matrix}0 \\ {I}_{NL} ( {X}_{NL} )\end{matrix} )$$

where G_{L} is the linear circuit equation matrix based on nodal analysis or modified nodal analysis, X_{NL} is the state vector controlling the nonlinear devices, X_{L} is the vector for node voltages and branch currents pertaining only to linear circuit elements, I_{L} is the total contribution of the linear devices to the right hand side, and I_{NL} is the contribution of the nonlinear devices controlled by X_{NL}. The prior art methodology for solving the matrix equation is to apply the Newton-Raphson technique to the left hand side of the equation (i.e., to G_{L}), but the present invention takes a different approach by applying Newton-Raphson iteration to the right hand side of the equation, which yields

$${G}_{L} ( \begin{matrix}{X}_{L}^{k + 1} \\ {X}_{NL}^{k + 1}\end{matrix} ) = {I}_{L} + ( \begin{matrix}0 \\ {I}_{NL} ( {X}_{NL}^{k} ) + {J}_{NL}^{k} ( {X}_{NL}^{k + 1} - {X}_{NL}^{k} )\end{matrix} )$$

where J_{NL}^{k} is the Jacobian matrix for the nonlinear devices

$${J}_{NL}^{k} = \frac{\partial {I}_{NL}}{\partial {X}_{NL}} {\vert}_{{X}_{NL}^{k}} .$$

The traditional approach to further solve this equation would be to move the Jacobian matrix from the right-hand side of the equation to the left-hand side and then solve the entire left-hand side linear system, but this method would require performing a new factorization at each iteration since J_{NL}^{k} changes, which is extremely inefficient. The present invention simplifies the solution by recognizing that, if there are only a relatively small number of nonlinear devices, i.e., if the size of X_{NL} is small, the computation can be reduced at each iteration by focusing on the nonlinear vector.

The inverse of G_{L} may be partitioned according to the separation in the state vector as

$${G}_{L}^{- 1} = ( \begin{matrix}{R}_{LL} & {R}_{LN} \\ {R}_{NL} & {R}_{NN}\end{matrix} )$$

where R_{LL} is the submatrix portion of the inverse matrix whose elements are solely dependent on linear contributions, R_{LN} and R_{NL} are the submatrix portions of the inverse matrix whose elements depend on both linear and nonlinear contributions, and R_{NN} is the submatrix portion of the inverse matrix whose elements are solely dependent on nonlinear contributions. Using this partition, the earlier matrix equation can be decoupled into separate linear and nonlinear components as

X_{L}^{k+1}=(R_{LL}R_{LN})I_{L}+R_{LN}[I_{NL}X_{NL}^{k}+J_{NL}^{k}(X_{NL}^{k+1}−X_{NL}^{k})] and

X_{NL}^{k+1}=(R_{NL}R_{NN})I_{L}+R_{NN}[I_{NL}X_{NL}^{k}+J_{NL}^{k}(X_{NL}^{k+1}−X_{NL}^{k})].

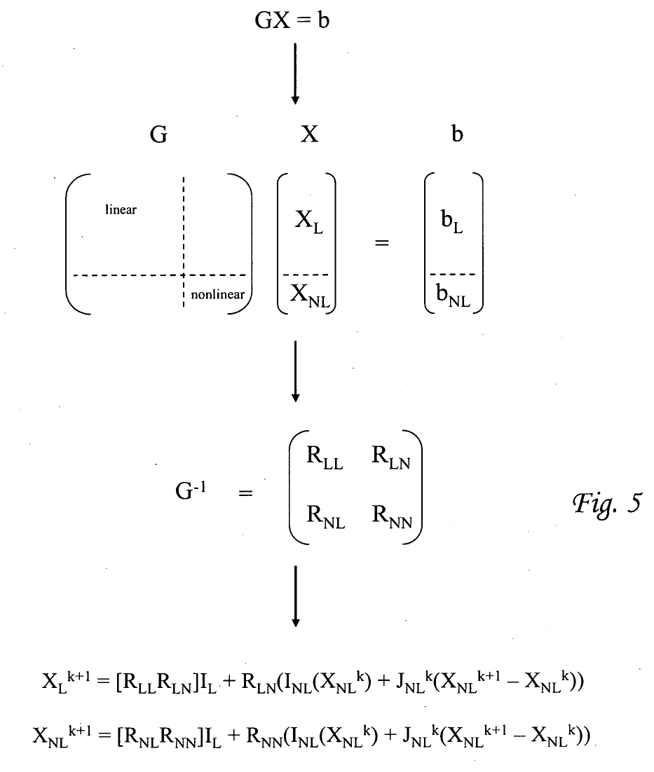

The partitioning of the inverse matrix and decoupling of the linear and nonlinear components is pictorially represented in FIG. 5. The dashed-line partition of the state matrix illustrates how the number of elements controlled solely by the nonlinear devices are relatively small in a dominantly linear circuit.

The iteration relations for X_{NL} can be derived from this last equation as

(E−R_{NN}J_{NL}^{k})X_{NL}^{k+1}=(R_{NL}R_{NN})I_{L}+R_{NN}(I_{NL}X_{NL}^{k}−J_{NL}^{k}X_{NL}^{k})

where E is the identity matrix. Accordingly, it is only necessary to solve a much smaller system.

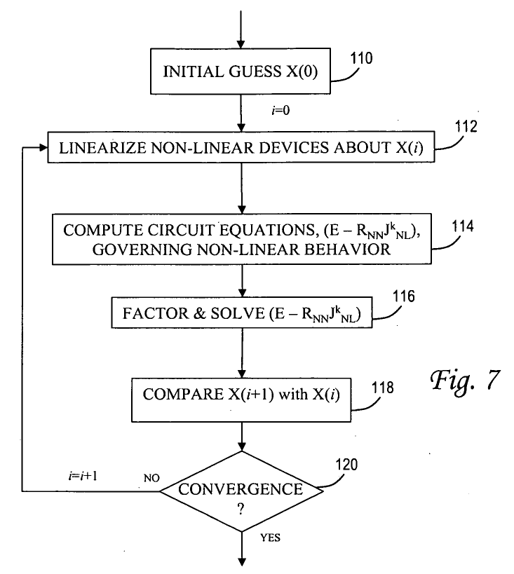

The independent (I_{L}) and dependent (I_{NL}) sources include voltage and current sources whose values are either constant or only a function of time. For example, v(t)=2.0*t is an independent voltage source, that is, the value v is not influenced by any other state in the circuit. Independent sources can be evaluated independent of the rest of the circuit. The dependent sources are the nonlinear devices. For example, FET transistors are typically modeled with voltage-controlled current sources, so the current in the transistor is a function of the terminal voltages. Dependent (nonlinear) sources are evaluated using the iterative procedures of FIG. 7.

This novel approach does require a minor amount of additional overhead in computing R_{NN}. The equation G_{L}X=eᵢ (eᵢ is a unit vector corresponding to a particular nonlinear state variable) must be solved N number of times, where N is the number of nonlinear devices, i.e., the size of the nonlinear vector X_{NL}. However, there is no need to re-compute and store R_{NL}, since (R_{NL}R_{NN})I_{L} does not change and can be computed by solving G_{L}X=I_{L} once. More significantly, X_{L}^{k+1} does not have to be re-computed during the iterations.

Once X_{NL} converges to χ_{NL}, the final complete solution can be computed by solving

$${G}_{L} X = {G}_{L} ( \begin{matrix}{X}_{L} \\ {X}_{NL}\end{matrix} ) = {I}_{L} + ( \begin{matrix}0 \\ {I}_{NL} ( {χ}_{NL} )\end{matrix} ) .$$

Convergence may be based on different criteria. It can be shown that the overall state vector X is convergent, that is, the norm of ΔX is less than a user-defined error tolerance ε for the overall state vector, when

$$‖ ( \begin{matrix}{R}_{LN} \\ {R}_{NN}\end{matrix} ) ‖ ‖ {J}_{NL}^{k} Δ {X}_{NL} ‖ < ɛ$$

where ∥ ∥ is the norm operation, and ΔX_{NL} is X_{NL}^{k+1}(iteration i+1)−X_{NL}^{k+1}(iteration i). In the illustrative implementation, the iterations terminate once this condition is met. For a dominantly linear circuit where X represents node voltages on the order of 1 Volt an exemplary value for ε is 10⁻⁶ Volts.

The present invention is particularly efficient in a fixed time-step transient analysis, i.e., where the time interval ΔT is constant, since G_{L} is also constant. In such a case, only one decomposition (lower/upper factorization) of G_{L} is needed for the first linearization, and the rest of the nonlinear solutions can be achieved with inexpensive forward and backward substitutions.

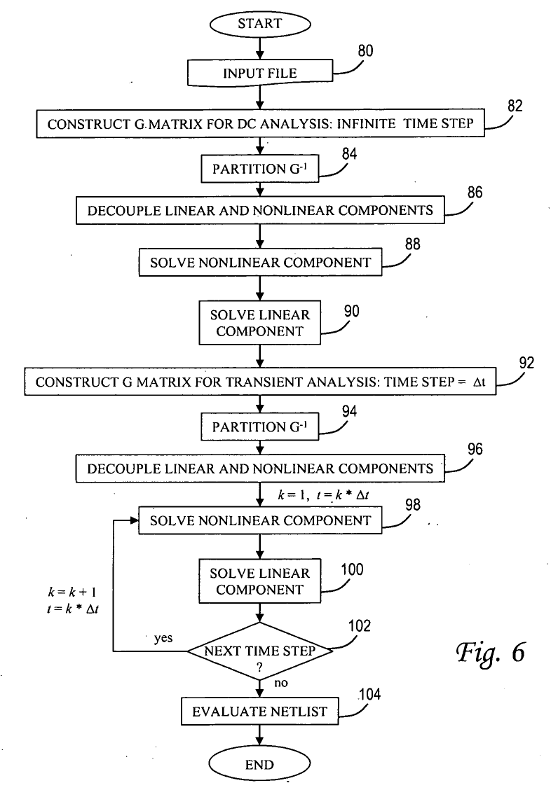

The present invention may be further understood with reference to FIGS. 6 and 7 which illustrate the logical flow for one implementation of the circuit simulation and linearization of nonlinear devices. The circuit simulation process begins by providing an input file containing a description of the circuit with resistance, inductance and capacitance values corresponding to respective nodes as well as characteristics of nonlinear devices such as transistors or diodes (80). This data is used to construct an initial circuit state matrix G for DC analysis (82), followed by partitioning of the inverse of that matrix into linear, nonlinear and mixed contributions (84). These contributions are used to decouple the linear and nonlinear components (86). The nonlinear component X_{NL} is solved first (88), followed by the linear component X_{L} (90). At this point in the process, an initial state (or steady state) of the system has been derived. The process then continues by constructing a new circuit state matrix for transient analysis (92). The inverse of the new state matrix is again partitioned (94), and the new linear and nonlinear components are decoupled (96). The new nonlinear component is solved (98), and then the linear component is solved (100). If the time has not reached the final time step (102), the time step is incremented (k=k+1, t=k*Δt) and the process returns to step 98 for successive time steps. If a constant time step were not used, the process would return instead to step 92, but by using a constant time step the present invention is able to avoid further recalculation of the state matrix. After the components have been computed for the final time step, the simulation process is complete and the netlist can be evaluated for design compliance (104).

FIG. 7 illustrates the iterative procedure for solving the nonlinear component, which begins with an initial guess X(iteration 0) for the roots during the first iteration i=0 (110). The nonlinear devices are then linearized about X(iteration i) (112). The circuit equations governing nonlinear behavior are computed (114), and LU factorization is used to solve them (116). The resulting roots X(iteration i+1) are compared with the previous roots X(iteration i) to determine if the difference is less than the convergence condition described above (118). If the difference is smaller than the threshold then the solution is converging and the process is complete; if not, the process continues iteratively at step 112, incrementing i (120). By decoupling the nonlinear and linear portions, the iterative steps (88, 98) of the circuit simulation operate on a much smaller set of equations, i.e., the number of nonlinear devices in the circuit, making this algorithm much more efficient than prior tools for modeling dominantly linear circuits.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

What is claimed is:

1. A computer-implemented method of simulating a circuit parameter for a dominantly linear circuit, comprising:
constructing a circuit equation matrix whose elements correspond to nodes of the circuit;
defining linear, nonlinear and mixed contributions to the circuit parameter based on a partition of an inverse matrix of the circuit equation matrix;
computing a nonlinear component using the nonlinear contribution and a first mixed contribution;
computing a linear component using the linear contribution and a second mixed contribution; and
combining the nonlinear and linear components to yield a state of the circuit parameter for a given time step.

2. The method of claim 1 wherein said computing steps and said combining step are iteratively repeated for successive time steps which are separated by a constant time interval.

3. The method of claim 1 wherein said computing of the linear component further uses the nonlinear component.

4. The method of claim 1 wherein said computing of the nonlinear component includes Newton-Raphson iterations to linearize nonlinear devices of the circuit.

5. The method of claim 4 wherein the nonlinear component X_{NL}^{k+1} for a given time step k+1 is iteratively computed using the relationship:
X_{NL}^{k+1}=(R_{NL}R_{NN})I_{L}+R_{NN}[I_{NL}X_{NL}^{k}+J_{NL}^{k}(X_{NL}^{k+1}−X_{NL}^{k})],
where R_{NL} is a submatrix of the inverse matrix corresponding to the mixed contributions, R_{NN} is a submatrix of the inverse matrix corresponding to the nonlinear contribution, I_{L} is a contribution of all linear devices of the circuit, I_{NL} is a contribution of all nonlinear devices of the circuit, and J_{NL}^{k} is a Jacobian matrix for all nonlinear devices of the circuit.

6. The method of claim 5 wherein the linear component X_{L}^{k+1} for a given time step k+1 is iteratively computed using the relationship:
X_{L}^{k+1}=(R_{LL}R_{LN})I_{L}+R_{LN}[I_{NL}X_{NL}^{k}+J_{NL}^{k}(X_{NL}^{k+1}−X_{NL}^{k})]
where R_{LL} is a submatrix of the inverse matrix corresponding to the linear contribution and R_{LN} is another submatrix of the inverse matrix corresponding to the mixed contributions.

7. The method of claim 5 wherein the iterations terminate once the convergence condition
$$\vert Δ X \vert \leq \vert ( \begin{matrix}{R}_{LN} \\ {R}_{NN}\end{matrix} ) \vert \vert {J}_{NL}^{k} Δ {X}_{NL} \vert < ɛ$$
is satisfied, where ΔX is X^{k+1}(iteration i+1)−X^{k+1}(iteration i), ΔX_{NL} is X_{NL}^{k+1}(iteration i+1)−X_{NL}^{k+1}(iteration i), and ε is a user-defined error tolerance.

8. A computer system comprising:
one or more processors which process program instructions;
a memory device connected to said one or more processors; and
program instructions residing in said memory device for simulating a circuit parameter for a dominantly linear circuit by constructing a circuit equation matrix whose elements correspond to nodes of the circuit, defining linear, nonlinear and mixed contributions to the circuit parameter based on a partition of an inverse matrix of the circuit equation matrix, computing a nonlinear component using the nonlinear contribution and a first mixed contribution, computing a linear component using the linear contribution and a second mixed contribution, and combining the nonlinear and linear components to yield a state of the circuit parameter for a given time step.

9. The computer system of claim 8 wherein the computing steps and the combining step are iteratively repeated for successive time steps which are separated by a constant time interval.

10. The computer system of claim 8 wherein the computing of the linear component further uses the nonlinear component.

11. The computer system of claim 8 wherein the computing of the nonlinear component includes Newton-Raphson iterations to linearize nonlinear devices of the circuit.

12. The computer system of claim 11 wherein the nonlinear component X_{NL}^{k+1} for a given time step k+1 is iteratively computed using the relationship:
X_{NL}^{k+1}=(R_{NL}R_{NN})I_{L}+R_{NN}[I_{NL}X_{NL}^{k}+J_{NL}^{k}(X_{NL}^{k+1}−X_{NL}^{k})],
where R_{NL} is a submatrix of the inverse matrix corresponding to the mixed contributions, R_{NN} is a submatrix of the inverse matrix corresponding to the nonlinear contribution, I_{L} is a contribution of all linear devices of the circuit, I_{NL} is a contribution of all nonlinear devices of the circuit, and J_{NL}^{k} is a Jacobian matrix for all nonlinear devices of the circuit.

13. The computer system of claim 12 wherein the linear component X_{L}^{k+1} for a given time step k+1 is iteratively computed using the relationship:
X_{L}^{k+1}=(R_{LL}R_{LN})I_{L}+R_{LN}[I_{NL}X_{NL}^{k}+J_{NL}^{k}(X_{NL}^{k+1}−X_{NL}^{k})]
where R_{LL} is a submatrix of the inverse matrix corresponding to the linear contribution and R_{LN} is another submatrix of the inverse matrix corresponding to the mixed contributions.

14. The computer system of claim 12 wherein the iterations terminate once the convergence condition
$$\vert Δ X \vert \leq \vert ( \begin{matrix}{R}_{LN} \\ {R}_{NN}\end{matrix} ) \vert \vert {J}_{NL}^{k} Δ {X}_{NL} \vert < ɛ$$
is satisfied, where ΔX is X^{k+1}(iteration i+1)−X^{k+1}(iteration i), ΔX_{NL} is X_{NL}^{k+1}(iteration i+1)−X_{NL}^{k+1}(iteration i), and ε is a user-defined error tolerance.

15. A computer program product comprising:
a computer-readable medium; and
program instructions residing in said medium for simulating a circuit parameter for a dominantly linear circuit by constructing a circuit equation matrix whose elements correspond to nodes of the circuit, defining linear, nonlinear and mixed contributions to the circuit parameter based on a partition of an inverse matrix of the circuit equation matrix, computing a nonlinear component using the nonlinear contribution and a first mixed contribution, computing a linear component using the linear contribution and a second mixed contribution, and combining the nonlinear and linear components to yield a state of the circuit parameter for a given time step.

16. The computer system of claim 15 wherein the computing steps and the combining step are iteratively repeated for successive time steps which are separated by a constant time interval.

17. The computer system of claim 15 wherein the computing of the nonlinear component includes Newton-Raphson iterations to linearize nonlinear devices of the circuit.

18. The computer system of claim 17 wherein the nonlinear component X_{NL}^{k+1} for a given time step k+1 is iteratively computed using the relationship:
X_{NL}^{k+1}=(R_{NL}R_{NN})I_{L}+R_{NN}[I_{NL}X_{NL}^{k}+J_{NL}^{k}(X_{NL}^{k+1}−X_{NL}^{k})],
where R_{NL} is a submatrix of the inverse matrix corresponding to the mixed contributions, R_{NN} is a submatrix of the inverse matrix corresponding to the nonlinear contribution, I_{L} is a contribution of all linear devices of the circuit, I_{NL} is a contribution of all nonlinear devices of the circuit, and J_{NL}^{k} is a Jacobian matrix for all nonlinear devices of the circuit.

19. The computer system of claim 18 wherein the linear component X_{L}^{k+1} for a given time step k+1 is iteratively computed using the relationship:
X_{L}^{k+1}=(R_{LL}R_{LN})I_{NL}+R_{LN}[I_{NL}X_{NL}^{k}+J_{NL}^{k}(X_{NL}^{k+1}−X_{NL}^{k})]
where R_{LL} is a submatrix of the inverse matrix corresponding to the linear contribution and R_{LN} is another submatrix of the inverse matrix corresponding to the mixed contributions.

20. The computer system of claim 18 wherein the iterations terminate once the convergence condition
$$\vert Δ X \vert \leq \vert ( \begin{matrix}{R}_{LN} \\ {R}_{NN}\end{matrix} ) \vert \vert {J}_{NL}^{k} Δ {X}_{NL} \vert < ɛ$$
is satisfied, where ΔX is X^{k+1}(iteration i+1)−X^{k+1}(iteration i), ΔX_{NL} is X_{NL}^{k+1}(iteration i+1)−X_{NL}^{k+1}(iteration i), and ε is a user-defined error tolerance.
